(19) United States
(12) Patent Application Publication
(10) Pub. No.: US 2026/0063134 A1
(43) Pub. Date: Mar. 5, 2026

(54) INTERNALLY PRESSURIZED AND LUBRICATED SHAFT SEALS AND BEARINGS FOR PUMPS

(71) Applicant: KnuCo 1, LLC, Weatherford, TX (US)

(72) Inventor: Michael Parker, JR., Mound House, NV (US)

(73) Assignee: KnuCo 1, LLC, Weatherford, TX (US)

(21) Appl. No.: 19/197,218

(22) Filed: May 2, 2025

Related U.S. Application Data
(60) Provisional application No. 63/688,079, filed on Aug. 28, 2024.

(51) Int. Cl. F04D 29/12; F04D 7/00; F04D 29/06; F16J 15/46

(52) U.S. Cl. CPC F04D 29/126; F04D 7/00; F04D 29/061; F16J 15/46

(57) ABSTRACT

A device for sealing a pump that includes a sealing ring with an interface for mechanically interacting with a shaft of the pump, and a cavity accessible by an orifice with a filler valve. Said cavity is configured to be pressurized with a medium during pump operation, and the sealing ring is configured to increase pressure on the shaft when the medium is added, and to reduce pressure on the shaft when the medium is removed. A system for pumping a material that includes a pump, comprising an impeller for moving the material, a shaft for turning the impeller, and a seal for preventing contact between the material and the shaft. Wherein the seal includes an interface for mechanically interacting with the shaft, and a cavity for selectively pressurizing or depressurizing the seal during operation of the pump.

### CROSS-REFERENCE TO RELATED APPLICATIONS

This application claims priority to U.S. Provisional Ser. No. 63/688,079, filed Aug. 28, 2024, which is hereby incorporated by reference herein in its entirety.

### BACKGROUND

### Field of the Invention

The disclosed invention relates to pumping liquid and liquified solids, i.e., slurries, using a pump that includes a rotary shaft that passes through the pump casing, and that requires a sealing means to retain liquid inside the pump. Specifically, the invention includes devices, systems, and methods for providing internally pressurized shaft seals, as well as via-seal and via-shaft lubrication, for seals and bearings used with trans-casing rotary pump shafts.

### Relevant Background

All fluid and slurry pumps that have a rotating shaft that passes through the pump casing, or trans-casing rotary pumps, require a robust seal. These seals have traditionally caused problems during operation, including increased downtime, increased maintenance, and excessive costs to the operator. Such pumps, including centrifugal pumps, piston pumps, stator pumps, screw pumps, positive displacement pumps, diaphragm pumps, self-priming pumps, jet pumps, drill pumps, drill mud pumps, etc., are powerful pumps that move large amounts of abrasive and corrosive solids mixed with a carrier liquid, such as water. Trans-casing rotary pumps are used extensively in mining, oil process pumping, wastewater treatment, paper and pulp manufacture, dredging operations, coal ash pumping, and other suitable purposes.

The physical demands on trans-casing rotary pumps are considerable due to the high turning velocity of the pump components, and the corrosive nature of the materials being pumped. Trans-casing rotary pumps operate by rapidly turning an impeller by means of a transmission shaft connected to a motor. The shaft is a precision component that is supported by means of a set of bearings that reduce friction from rotational motion. Further, the shaft must be sealed to protect it from the corrosive effects of the pumped material, which if brought into contact with the rotating shaft, can lead to rapid mechanical wear and failure.

Of particular concern is the period near the end of pump operation, which is when most shaft damage occurs. When a trans-casing rotary pump is shut down, a residual amount of pumped material remains within the pump and pipe system. Such remaining material migrates to the lowest point within the system, and if the seal leaks even a marginal amount, solids will infiltrate between the shaft and seal. To counter this, some gland seals are designed with a “gland water” feed to flush out residual pumped material, or if the pumped material is non-abrasive, a mechanical seal may be used. However, the preferred solution to minimize seal leakage is the addition of an expeller, a secondary turbine pump that removes pumped material from around the seal during pump operation. Unfortunately, expellers shut down when the main impeller shuts down, allowing pumped material to build pressure on the seal, at shutdown. Thus, even the best solution to trans-casing rotary pump seal failure results in leakage and shaft damage. Pump downtime due to shaft failure is a source of substantial expense in lost production for many industries. Further, the repair or replacement of pump shafts and other components is a major expense in itself. The poor reliability of trans-casing rotary pumps is largely the result of inadequate sealing for the transmission shaft, and ineffective lubrication for seals and shaft bearings.

Current seal configurations allow unacceptable levels of material infiltration and shaft damage. With reference to FIG. 1A is depicted a prior art wet gland seal 100. To prevent leakage around a shaft 110 rotating on its longitudinal axis 12, a wet gland seal 120 is traditionally used. Wet gland seals are circumferential seals with a stuffing box 130 or expeller ring that supports wet gland packing material 140, or other mechanical sealing material, that is held in place by a backing ring 150. The backing ring is tightened against the packing material, which in turn is pressed into the stuffing box. The compression applied to the packing material longitudinally causes it to expand axially and create a seal against the shaft. However, because pressure is applied primarily by the backing ring, wet gland seals do not evenly distribute axial pressure on the shaft.

With reference to FIG. 1B is depicted a block diagram of a prior art wet gland seal 100, wherein like components are numbered as like components of FIG. 1A. As shown, the backing ring 150 applies mechanical pressure 14 to the packing material 140 primarily adjacent to the ring 141, while the packing material opposite the ring 142 sees less pressure. The amount of sealing pressure exerted by the packing material on the shaft, therefore, is highest in the area 141 near the backing ring, and drops rapidly toward the back of the stuffing box 130. During trans-casing rotary pump operation and shutdown, the packing material experiences the most fluid pressure 16 at the stuffing box end 142, making wet gland seals particularly susceptible to material infiltration. Because of this, most gland seals are supplemented by use of additional lip seals added along the shaft to provide additional protection against infiltration.

Further, because properly installing and maintaining wet gland seals requires skilled labor, the assembly and servicing of these traditional shaft seals relies upon the skill of the person carrying out the assembly, which may vary. The result is inconsistent performance of the seal from one installation to the next, and increased pump downtime. Wet gland seals, therefore become a bottleneck for sustained pump operations.

With further reference to FIG. 1A, lubrication of the shaft 110 under the seal is also deficient. For most trans-casing rotary pumps, a lubricant, e.g., a grease, is manually or automatically applied through a lubrication point 160 that is external to the interface between the rotating shaft and the neck or lantern ring 170. Other trans-casing rotary pumps, e.g., those without an expeller, use water to lubricate the shaft. In such pumps, pressurized water is fed into the seal to prevent pumped material infiltration and provide lubrication. In both cases, lubricant is applied externally to the mechanical interface between the seal and shaft and must migrate to the effective location between the two surfaces. As a result, lubrication does not reliably reach all of the contact points between seal and shaft, resulting in shaft wear and premature failure.

Lubrication of shaft bearings is similarly lacking. Lubrication is normally provided into the bearing passage typically delivered from a grease zerk by a manual or automatic greasing method. As with the shaft seal, bearing lubricant is applied externally to the bearing assembly, and must therefore migrate to locations between the shaft and the bearing components.

Because of such deficiencies, a need exists for an improved shaft seal that is capable of preventing pumped material infiltration by applying specified levels of pressure evenly across the seal. Additionally, a seal is needed that can be repaired or replaced without the use of skilled labor, and wherein the performance of the seal is not dependent on the skill level of the individual performing the repair or installation. Also needed is a lubrication means that applies lubricant to the seal and bearing from a location adjacent to the friction points between the shaft on the one hand, and the seal or bearing assembly on the other.

These and other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out hereafter.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIGS. 1A and 1B depict a diagram of prior art centrifugal pump shaft sealing components;

FIG. 2A depicts a cutaway side view of a pump assembly as used in embodiments of the disclosed invention;

FIG. 2B is a top perspective cutaway view of a pump with a seal as used in embodiments of the disclosed invention

FIG. 3A depicts a cutaway side view of a shaft and impeller assembly including a cross-sectional depiction of a seal as used in embodiments of the disclosed invention.

FIG. 3B depicts a close-up view of a portion of FIG. 3A, showing a side cutaway view of a seal as used in embodiments of the disclosed invention.

FIG. 4 depicts a side cutaway view of a portion of a shaft with seal assembly as used in embodiments of the disclosed invention.

FIG. 5 depicts a side cutaway view of a portion of a shaft with seal assembly, as used in embodiments of the disclosed invention;

FIG. 6 depicts a side cutaway view of a portion of a shaft with seal assembly, as used in embodiments of the disclosed invention;

FIG. 7 depicts a side cutaway view of a portion of a shaft with seal assembly, as used in embodiments of the disclosed invention;

FIG. 8 depicts a side cutaway view of a portion of a shaft with seal assembly, as used in embodiments of the disclosed invention;

FIGS. 9A, 9B, and 9C depict a perspective view, a side cutout view, and an end cutout view, respectively, of an embodiment of the sealing ring, as used in embodiments of the disclosed invention;

FIGS. 10A, 10B, 10C, and 10D depict a perspective view, a perspective cutout view, a side translucent view, and an end view, respectively, of a sealing ring as used in embodiments of the disclosed invention;

FIGS. 11A, 11B, 11C, and 11D depict a perspective view, a perspective cutout view, a side cutout view, and an end view, respectively, of a sealing ring as used in embodiments of the disclosed invention;

FIGS. 12A, 12B, 12C, and 12D depict a perspective view, a perspective cutout view, a side cutaway view, and an end view, respectively, of a D-ring as used in embodiments of the disclosed invention;

FIGS. 13A, 13B, 13C, 13D, and 13E depict a perspective view, a perspective cutout view, a side cutaway view, an end view, and a top view, respectively, of a D-ring as used in embodiments of the disclosed invention;

FIGS. 14A, 14B, 14C, and 14D depict a perspective view, a perspective cutout view, a side cutout view, and an end view, respectively, of a lubricated sealing ring as used in embodiments of the disclosed invention;

FIG. 15A depicts a cutaway side view of a shaft and impeller assembly including a cross-sectional depiction of a lubricated shaft seal, as used in embodiments of the disclosed invention;

FIG. 15B depicts a close-up cutaway side view of a shaft including a cross-sectional depiction of a lubricated shaft seal, as used in embodiments of the disclosed invention;

FIG. 16A depicts a cutaway side view of a shaft and impeller assembly including a cross-sectional depiction of a lubricated shaft seal and a lubricated bearing assembly, as used in embodiments of the disclosed invention; and

FIG. 16B depicts a close-up cutaway side view of a shaft including a cross-sectional depiction of a lubricated shaft seal and a lubricated bearing assembly, as used in embodiments of the disclosed invention.

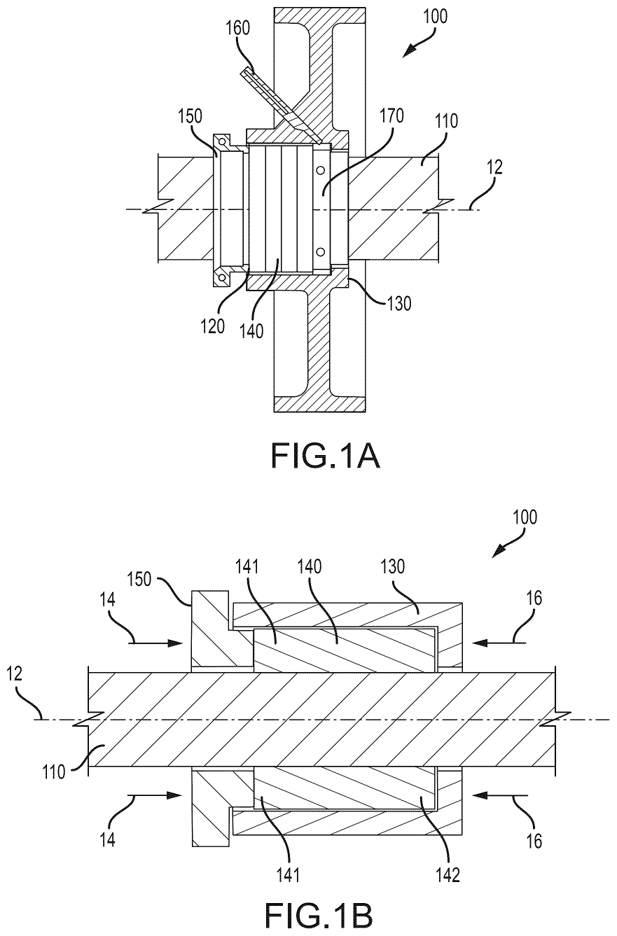

The Figures depict embodiments of the present invention for purposes of illustration only. One skilled in the art will readily recognize from the following discussion that alternative embodiments of the structures and methods illustrated herein may be employed without departing from the principles of the invention described herein.

### DEFINITIONS

Passage means a passage for conveying lubrication to a contact point.

Gland means a seal packing material comprised of rope or shaped graphite wrap treated with grease or wax.

Zerk means a lubrication point.

Static head means the pressure caused by the weight of a liquid column.

Dynamic head means the pressure a pump creates over and above static pressure and pipe losses for the pump configuration.

Net positive suction head (NPSH) means the difference between the inlet pressure of the pump and the lowest level of pressure inside the pump.

Available NPSH (NPSHA) is a measure of how close the pumped material is at a given point to cavitating.

Required NPSH (NPSHR) means the head value at the inlet of a pump required to keep the pumped material from cavitating.

### Description

The disclosed invention relates to devices, systems, and methods for pressurized trans-casing rotary pump shaft seals and via-seal and via-shaft lubrication for shaft seals and bearings.

As disclosed, the trans-casing rotary pump seal system includes an internally pressurized sealing ring configured to provide a specified pressure on the pump shaft that is evenly distributed across the width of the sealing ring and around its circumference. The seal has an internal cavity or bladder that is pressurized, i.e., charged or inflated, with a medium, i.e., a gas or a liquid, suitable for the application. In the case of fluids, the seal may be filled or partially filled with water, antifreeze, a coolant, hydraulic fluid, or other suitable hydrocarbon, depending on operational requirements. The gas may be ambient or vaporous air or may comprise one or more of the industrial or noble gases such as nitrogen, CO₂, or argon. Gas pressure may be supplied, for example, by a standard or modified tire pump. In other embodiments, a gel, such as an aerosol gel, or a thixotropic or rheopexic gel, may be used as the medium.

In some embodiments, the interface between the seal and the shaft is characterized by a smooth or ridged surface. In other embodiments, the seal is comprised of a set of one or more D-rings, which may be solid or inflatable. In another embodiment, traditional gland seal packing material is paired with an internally pressurized sealing ring to provide a seal having evenly distributed pressure.

Also disclosed is a lubrication method for the seal that includes a via-seal lubrication delivery system using perforations in the interface to provide externally fed lubrication substances to the external surface of the shaft underneath the seal to provide evenly distributed and constant lubrication between the shaft and the seal mechanism.

Also disclosed is a lubrication method for the seal that includes a via-shaft lubrication delivery system using a circumferential feed mechanism to provide externally fed lubrication substances into a main passage or bore in the center of the shaft. The passage is accessed at an inlet by a perpendicular or sloped passage of similar size to the main passage. The passage delivers lubrication to the external surface of the shaft underneath the seal to provide evenly distributed and constant lubrication between the shaft and the seal mechanism. In another embodiment, a similar lubrication system provides lubrication into bearings supporting a rotating pump shaft.

The disclosed invention will now be described in detail with reference to several embodiments thereof as illustrated in the accompanying Figures. In the following description, specific details are set forth in order to provide a thorough understanding of embodiments of the disclosed invention. It will be apparent, however, to one skilled in the art that embodiments may be practiced without some or all of these specific details. In other instances, well known process steps and/or structures have not been described in detail in order to not unnecessarily obscure the invention. The features and advantages of embodiments may be better understood with reference to the drawings and discussions that follow.

It should be apparent to those skilled in the art that the described embodiments of the disclosed invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the disclosed invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the disclosed invention as the embodiments disclosed herein are merely exemplary.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used to describe one element or feature's relationship to another element(s) or feature(s) as illustrated in the figures. Such spatially relative terms are intended to encompass different orientations of a device in use or operation in addition to the orientation depicted in the figures. For example, if a device in the figures is inverted, elements described as “under,” or “beneath” other elements or features would then be oriented “over” the other elements or features. Thus, the exemplary term “under” can encompass both an orientation of “over” and “under”. The device may be otherwise oriented (rotated 90 degrees (°) or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

### Internally Pressurized Shaft Seals

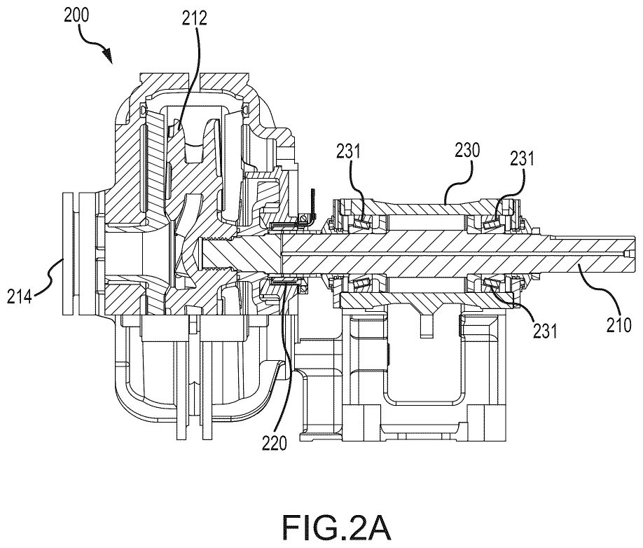

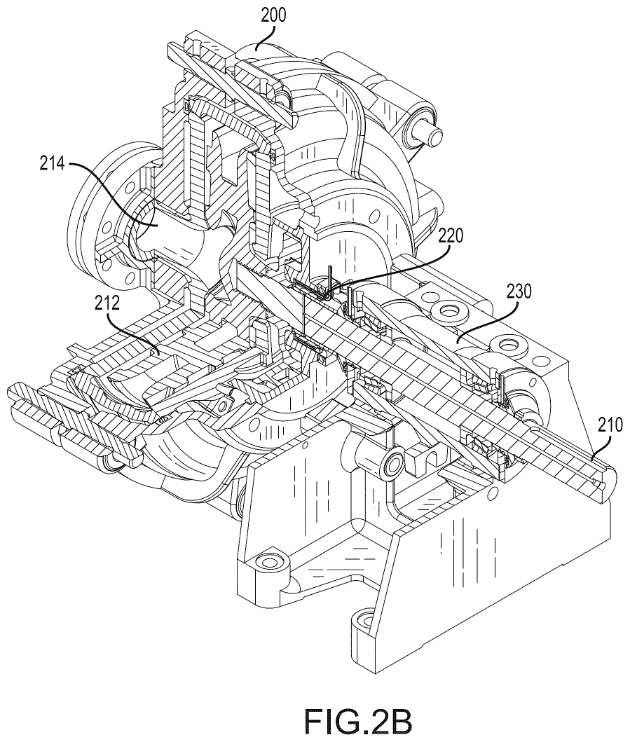

With reference to FIG. 2A is shown a partial cutaway side view of a pump assembly 200 as used in embodiments of the disclosed invention. The pump includes a shaft 210 that is for tuning an impeller 212. When rotated, the impeller draws pumped material through an inlet 214 and into the pump body. The shaft passes through a bearing assembly 230, which houses one or more bearings 231 (two are shown) to reduce friction when the shaft rotates. A seal assembly 220 prevents pumped material from contacting the shaft and bearing assembly. With reference to FIG. 2B is a top perspective partial cutaway view of the pump assembly 200 as used in the disclosed invention. The shaft 210 is attached to the impeller 212, which when rotated draws pumped material through the inlet 214 and into the pump body. The shaft passes through the bearing assembly 230 and the seal assembly 220.

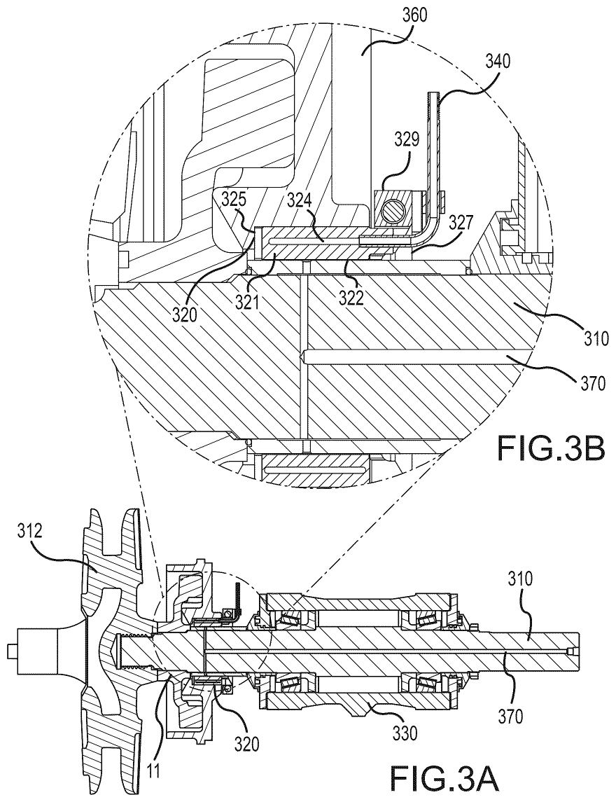

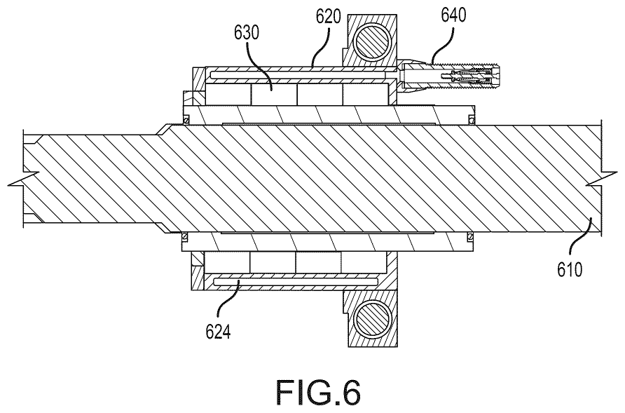

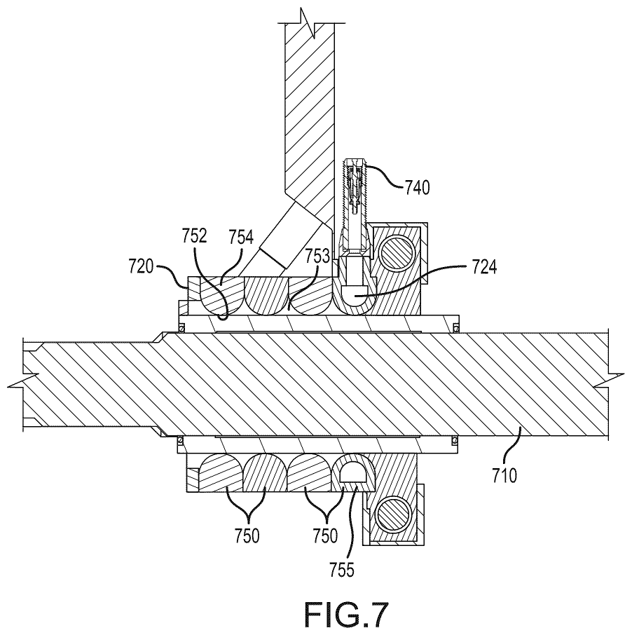

With reference to FIG. 3A, is shown a cutaway side view of a shaft and impeller assembly including a cross-sectional depiction of a seal as used in embodiments of the disclosed invention. A trans-casing rotary pump transmission shaft 310 turns an impeller 312 and passes through a bearing assembly 330 and a seal assembly 320. In this embodiment, the sealing ring 321 is lubricated by use of a channel or passage 370 that carries lubricant inside the shaft to contact points between the seal interface 322 and the outer surface of the shaft. In FIGS. 6 and 7 referenced below, the shaft does not feature a passage to provide lubrication to the seal, showing that embodiments of the disclosed seals also may be used with traditional lubrication methods. With reference to FIG. 3B, is depicted a close-up view of the area within the circle 11 of FIG. 3A, showing a side cutaway view of a seal 320 as used in embodiments of the disclosed invention. The seal has an inlet or impeller side 325 located nearest the impeller (if one is included), and a bearing side, 327 located opposite the inlet. A gland 329 is located on the bearing side of the seal assembly. A sealing ring 321 mechanically interacts with the shaft through an interface 322, which in this embodiment is flat or smooth, i.e., without ridges or grooves.

A flat interface provides a larger surface area for contact between the seal and shaft for applications in which the static head on the inlet side of the seal places increased pressure on the seal. For example, seals having a smooth interface surface are preferred for pumps operating without an expeller because such pumps experience high pressures throughout their operation. Similarly, pumps equipped with a seal that only inflates when the pump is slowing down or stopped will require additional infiltration resistance while turning at operational speeds. Finally, pumps that operate at low temperatures benefit from a flat seal because such seals are capable of maintaining a higher operational pressure.

The sealing ring 321 includes an internal cavity 324 that is configured to be inflated or charged with a medium. The internal cavity is inflated or deflated to provide a specified amount of pressure between the interface 322 and shaft 310. By applying uniform pressure from within the sealing ring, the disclosed seal assembly provides superior performance without the use of gland packing material, a backing ring, or supplemental lip seals. The amount of pressure applied by the sealing ring is adjustable depending on the application or pumping environment. For example, the seal may be pressurized to match or exceed pump outlet pressure, which provides superior infiltration resistance. Because the internally pressurized sealing ring is able to apply higher pressures to the shaft, a pump can operate at a higher discharge pressure and a higher net positive suction head pressure than possible with a traditional gland seal. This is because operation at higher discharge pressure and NPSH subjects the seal to corresponding high pressures. As disclosed, the internally pressurized sealing rings provide improved pump performance, and reduce pump downtime and maintenance costs by better preventing pumped material infiltration.

The sealing ring may also be deflated or contracted to aid operations by releasing the medium from the internal cavity. A vacuum or negative pressure within the cavity may also be created by removing the medium through use of suction. Deflating the sealing ring during pump operation removes pressure from the shaft, thereby reducing friction between the seal and shaft. In cases where the pump is operating at lower NPSH, or when the pump has reached steady state operation, the external pressures placed on the seal are lower, and a corresponding lower internal pressure may be sufficient to prevent infiltration. Internal sealing ring pressure may therefore be tailored to provide pressure so that friction and pumped material infiltration are both minimized. The sealing ring may also be deflated to aid in seal replacement. Once a sealing ring has reached the end of its useful life, it may be deflated to aid removal, and a new ring may similarly be deflated to facilitate installation. If a sealing ring is retrofitted to an existing seal assembly, deflation may improve installation by reducing the ring's size, allowing the installer to maneuver the ring within existing stuffing box structures.

The choice of filler material has implications for sealing ring and pump performance. For example, antifreeze may be used in cold environments to prevent freeze and rupture of the seal. Nitrogen reduces heat retention and provides stable expansion in high head applications. Carbon dioxide has similar performance characteristics as nitrogen but can acidify or stiffen sealing ring materials. Liquid filler material allows faster heat dissipation. In embodiments using perforated sealing rings, a lubricant e.g., an oil or grease, may be used as a filler substance, and may be transferred to the shaft interface for via-seal lubrication.

The cavity is filled or emptied through a filler valve 340, which in this embodiment is oriented vertically, and is located in open space outside the wall of the pump housing or stuffing box 360. In this orientation, the valve 340 feeds into the internal cavity 324 horizontally.

The filler valve may be a Schrader valve or other suitable valve type for gaseous or liquid filler material. Valve component construction is at least partially determined by the needs of the application. For example, slurries in leaching circuits expose pump components to corrosive chemicals, e.g., sulfuric or hydrochloric acid, hydrogen peroxide, cyanide, sodium hydroxide, etc., and therefore chemical-resistant materials would be required to construct the filler valve. Filler valve orientation may be dependent on the space available, for example, if the seal is retrofitted onto an existing pump, there may not be space dedicated to the filler valve, or valve positioning may require adaptation to the existing structure. In other cases, orientation is dependent on the material used to manufacture the valve, for example, axial stresses on the valve may cause failure if it is oriented vertically. The pump use environment may also require certain valve orientations or materials to reduce failure rates, for example, if the pump will experience vibrational, temperature, or pressure extremes. In general, the type or orientation of filler valve is not dependent on the various seal configurations as described herein.

A lubrication channel 370 located along the rotational axis of the shaft supplies lubricant to be deposited at the interface between the seal and shaft.

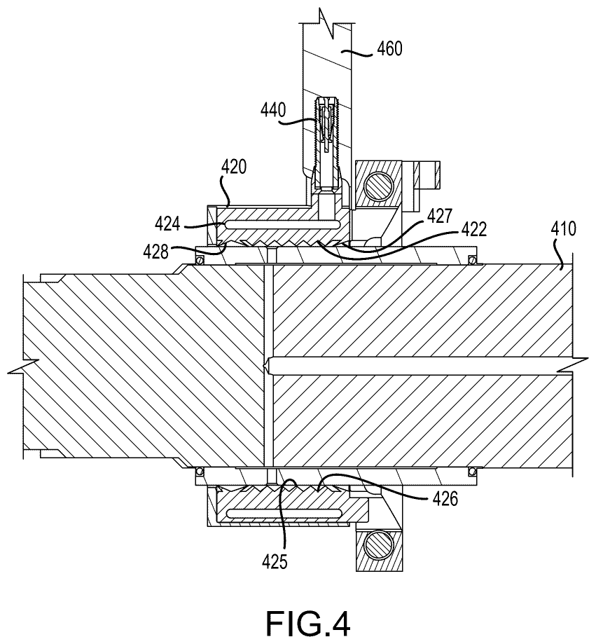

With reference to FIG. 4, is depicted a side cutaway view of a portion of a shaft 410 with seal assembly 420, as used in embodiments of the disclosed invention. In this embodiment, the filler valve 440 is oriented vertically, and is located in line with the wall of the stuffing box 460. The valve feeds into the internal cavity 424 vertically. A specialized interface 422 between the seal and shaft 410 is also shown. This interface includes a pattern of ridges 425 and grooves 426, wherein the ridges are configured to mechanically interact with the shaft to prevent the infiltration of pumped material, and the grooves are configured to form pockets for containing lubricant. Each ridge ends in a V-shaped point for contact with the shaft. Should the internal pressure of the pump push liquid towards the seal during operation or while the shaft is stationary, the V shape causes the sides of the ridges to roll toward the seal, increasing the surface area of the interface and improving the seal's resistance to infiltration.

Also visible are edge features 427, 428 located on each edge of the seal that serve as incorporated lip seals. In this embodiment, a single flange 427 is located on the bearing side of the seal, while a double flange 428 is located on the inlet side of the seal. These features capture lubricant and hold it in place near the edges of the sealing ring to form the lip seals. The shape of the flanges increases contact area with the shaft while retaining flexibility. Edge features may be molded with co-polymers to achieve specified performance characteristics. The incorporated lip seals fortify the relatively vulnerable edges of the seal to increase resistance to pumped material infiltration.

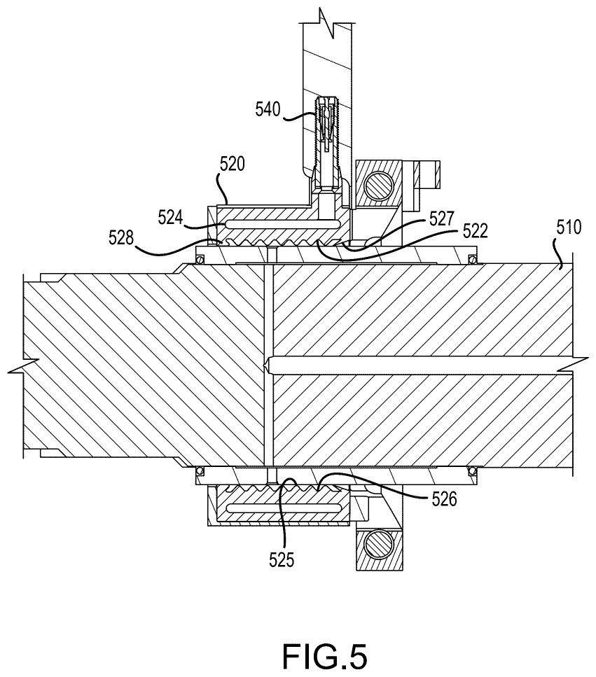

With reference to FIG. 5, is depicted a side cutaway view of a portion of a shaft 510 with seal assembly 520, as used in embodiments of the disclosed invention. In this embodiment, an alternative interface 522 between the seal and shaft 510 is shown. This interface includes a pattern of ridges 525 and grooves 526, wherein the ridges are rounded as compared to the ridge pattern shown in FIG. 4, items 425, 426. Due to their shape, the ridges contact the shaft in U-shaped points having increased surface area in contact with the shaft relative to V-shaped ridges. Similarly, the rounded shape of the grooves allows the seal to retain relatively more lubricant between the seal and shaft. Also included are edge features 527, 528 located on each end of the seal. In this embodiment, a single flange 527 is located on the bearing side of the seal, while a rounded foot 528 is located on the inlet side of the seal. Embodiments of the seal having relatively more rounded interface shapes allows the sealing ring to maintain the shape and pressure required for the application in cases requiring more flexible construction materials. In other words, the rounded interface allows the use of a softer or less rigid material while maintaining the pressure capacity of more rigid materials.

Such an interface pattern is preferred for pump operations requiring increased lubrication, such as those occurring in high temperature environments. Similarly, this pattern is preferred for pumps having a high head requirement since the seal experiences increased pressure when the pump is used to raise fluids vertically. This pattern also improves performance for pumps with a low NPSH. Low NPSH may be caused by, e.g., lifting fluid from a low level, use of long suction lines with high friction losses, or operating at high fluid temperatures. This embodiment is shown with a vertical filler valve 540 that feeds vertically into the internal cavity 524.

With reference to FIG. 6, is depicted a side cutaway view of a portion of a shaft 610 and a seal 620 as used in embodiments of the disclosed invention. In this embodiment, the seal includes traditional gland packing 630 to mechanically interact with the shaft 610. Instead of using a backing ring to press the material against a stuffing box, as in the prior art, the seal includes an internal cavity 624 that is pressurized to form the seal through use of a filler valve 640, as is described for other embodiments herein. Here, the filler valve is oriented horizontally, and feeds into the internal cavity 624 horizontally.

Where traditional seals are compressed an arbitrary amount by tightening the backing ring, the inflatable cavity allows a pump operator to apply a specified pressure to the seal. Additionally, a specified pressure distribution may be applied to the gland seal through the inflatable cavity, allowing an even pressure distribution across the gland packing. In some embodiments, the seal is configured to provide other suitable pressure configurations. The inflatable gland packing seal embodiment may be used to retrofit existing pumps where space is tightly constrained.

With reference to FIG. 7, is depicted a side cutaway view of a portion of a shaft 710 and a seal assembly 720 as used in embodiments of the disclosed invention. In this embodiment, the seal includes a plurality of D-ring seals 750 (four are shown) to mechanically interact with the shaft 710. The D-rings are shown arranged adjacent to one another laterally along the shaft. Each D-ring is shaped so that the center or apex 752 of the ring contacts the shaft, while the curved areas on the sides create channels 753 between adjacent D-rings to serve as reservoirs for lubricant. In some embodiments, when inflated, the D-ring rotates on its side so that the flat back of the ring is oriented orthogonally to the shaft surface (not shown). A D-ring seal may be solid 754, or hollow 755 wherein the hollow D-ring includes an internal cavity 724 that may be pressurized through use of a filler valve 740. When gas or fluid is introduced through the valve, the internal cavity inflates, causing pressure to be exerted on the shaft through the interface. In this embodiment, the filler valve is located on a flat outer surface of the hollow D-ring and feeds into the cavity orthogonally to the outer surface.

Different combinations of solid and hollow D-rings may be used to form a seal, e.g., a hollow D-ring 755 may be positioned at either edge of the seal. For hollow D-rings, alternate internal cavities are possible, such as a cavity with an elliptical cross-section, or a relatively smaller cavity, depending on operational requirements. In some embodiments, D-ring seals are used with a gel, such a rheopexic or thixotropic gel, to improve seal performance.

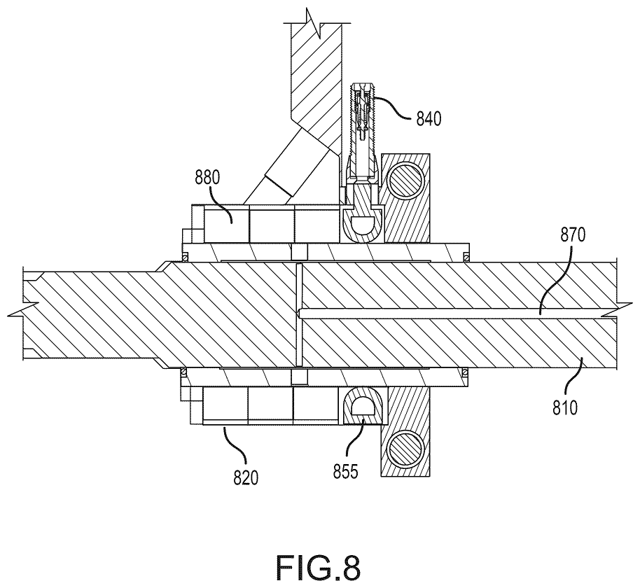

With reference to FIG. 8, is depicted a side cutaway view of a portion of a shaft 810 and a seal assembly 820 as used in embodiments of the disclosed invention. In this embodiment, the seal includes a combination-type seal assembly with one hollow D-ring seal 855 located at the bearing end of the seal, and a gland packing section 880 located at the inlet end of the seal. The hollow D-ring is inflated by use of a filler valve 840. While the gland seal section is shown without an internal cavity for inflation, such configurations are possible and contemplated. In this embodiment, the seal 820 is internally lubricated by means of a channel system 870.

For trans-casing rotary pumps employing an expeller, the disclosed pressurized seals may maintain pressure on the shaft after the expeller is shut down to provide continued protection of the shaft throughout the operational cycle. Additionally, the sealing ring can be tuned to provide a specified and uniform level of pressure between the seal and shaft. The amount of pressure applied to the shaft may also be varied across the seal, for example, higher pressures can be applied to the edges of the seal or the center of the seal, or a pressure gradient can be applied across the seal. For example, a seal assembly may be configured to provide a higher pressure on the bearing side where the pump experiences higher static pressures. Pressure may be varied by across the sealing ring by use of co-polymer molding. Materials having a specified stiffness or flexibility may be molded into the sealing ring to provide either a stiffer or more flexible cross section than other sections. For example, the outer 10 mm at either end of the sealing ring may have more flexible materials incorporated in the polymer, creating flexible sections at the edges. When inflated, these flexible sections would flex more than the center section, resulting in a 10 mm ring of higher pressures at either edge of the seal. Multiple configurations are possible and contemplated.

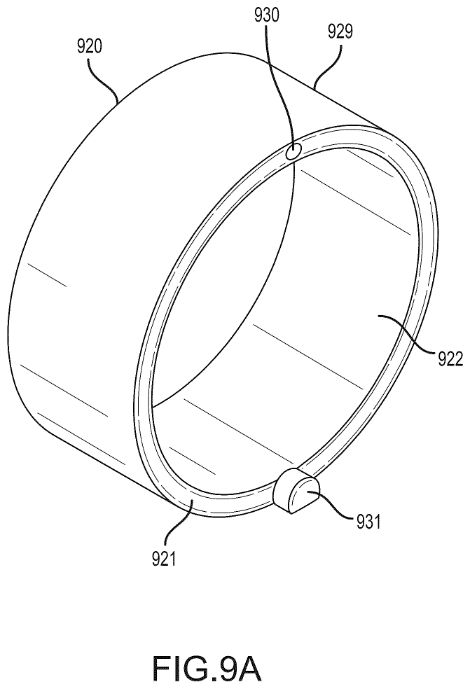

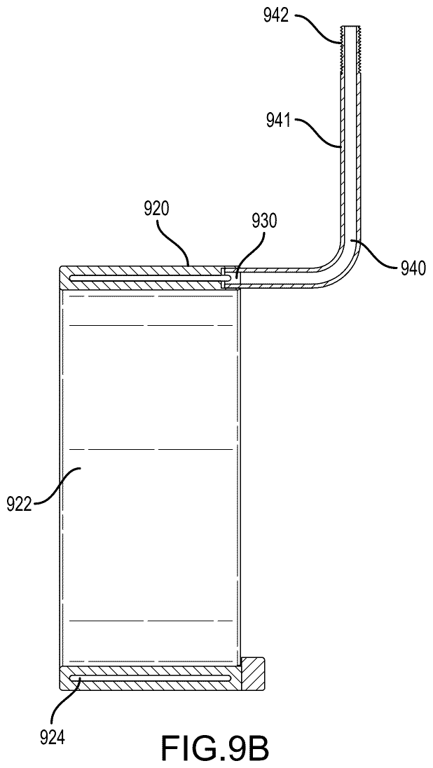

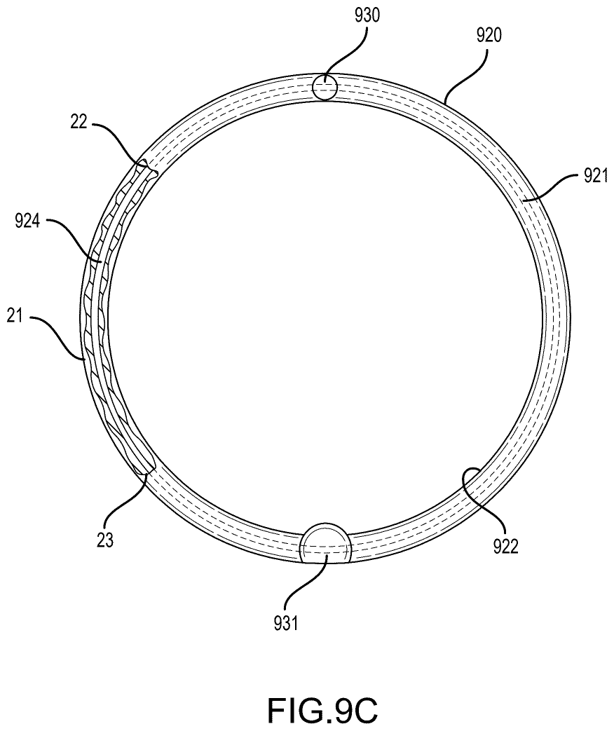

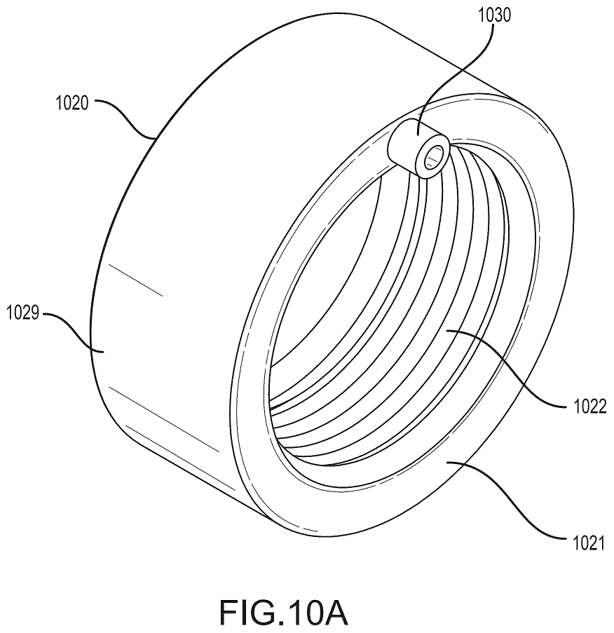

With reference to FIG. 9A is depicted a perspective view of an embodiment of a sealing ring 920 having a flat interface 922 for mechanically interacting with a rotating pump shaft (not shown). Opposite the interface is a flat outer surface 929, with an inner cavity (not shown) housed between the interface and outer surface. On each end of the sealing ring is a side wall 921 (one is visible). The side wall on the bearing side includes an inflation orifice 930 for accommodating a filler valve (not shown) for filling the inner cavity with air or liquid. Also on the side wall located 180° from the inflation orifice is a secondary fill location 931. The secondary fill location includes a reinforced area for installing a replacement or repair filler valve in the event the primary filler valve or orifice fails. The reinforced area is also configured to maintain the sealing ring in position by mechanically interacting with a clamp or bracket for such purpose (not shown).

The sealing ring 920 is made of high temperature silicone, rubbers, polymers, or other suitable material. Selection of material for the sealing ring construction may be dependent on the pumped material, for example, pumping certain chemicals will require a sealing ring made of certain polymers to ensure material compatibility. Further, for applications in which the seal requires increased solvent resistance, a softer or more flexible material is preferred.

With reference to FIG. 9B is depicted a side cross-sectional view of the sealing ring 920 with a flat interface 922. In this view, a cross section of the internal cavity 924 is visible, and is located within the body of the sealing ring bounded by the interface, the outer surface, and the side walls. In this view, a filler valve 940 is shown inserted into the inflation orifice 930, through which the valve accesses the internal cavity for purposes of conveying gas or liquid into the cavity under pressure. The filler valve is of tubular construction having a hollow valve stem 941, which in this case intersects the internal cavity from a horizontal orientation and then bends up 90° to a vertical orientation. Within the valve stem is a valve core (not shown), which is configured to control the flow of gas or liquid into and out of the internal cavity so that the cavity can be selectively pressurized or depressurized. A set of threads 942 is located at the end of the valve stem for accommodating a removeable dust cap (not shown). The dust cap prevents debris from fouling the valve core mechanism.

With reference to FIG. 9C is depicted a bearing side end view of the sealing ring 920 with a flat interface 922. Visible is the side wall 921, as are the inflation orifice 930 and the secondary fill site 931. The inflation orifice is located at the top of the sealing ring centered vertically in the side wall 921. The secondary site is located 180° around the sealing ring and includes a flattened bottom surface to conform to the curvature of the outer surface, and a top portion of the secondary fill site extends past the interface toward the center of the sealing ring.

A cutout section 21 is depicted between lines 22 and 23. Within the cutout section, a portion of the side wall has been removed so that a cross section of the internal cavity 924 is visible. The sealing ring is sized based on the size of the stuffing box of the pump, and the pump manufacturer, while the stuffing box is sized based on the pump size and the application for use.

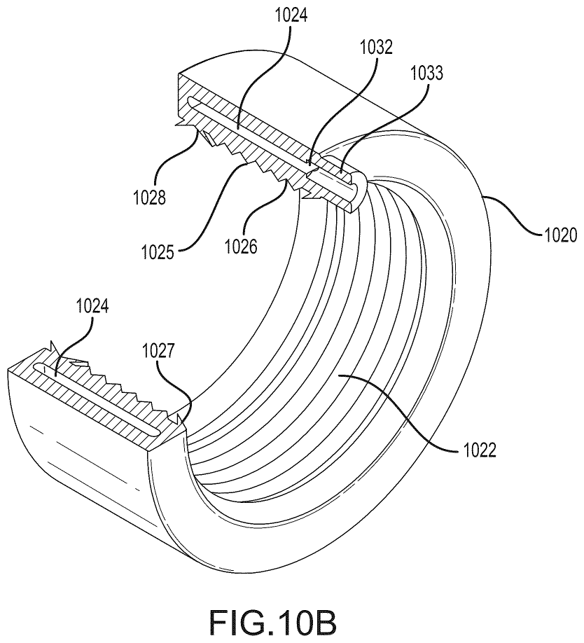

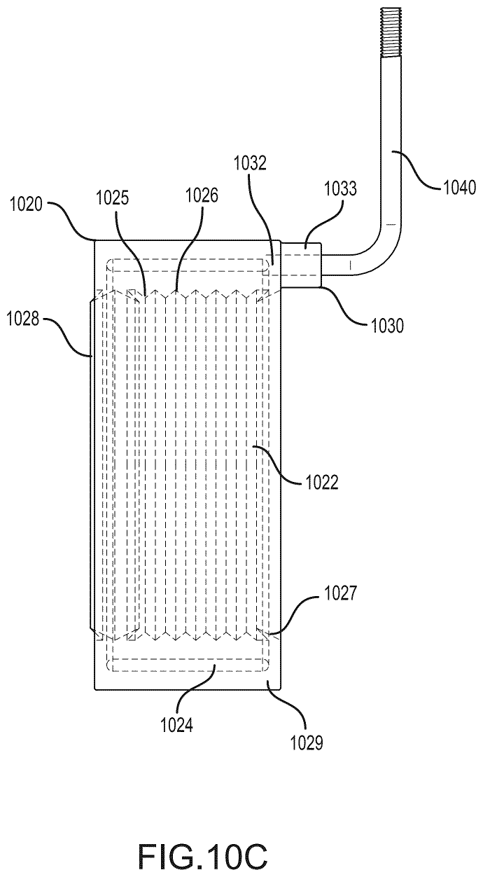

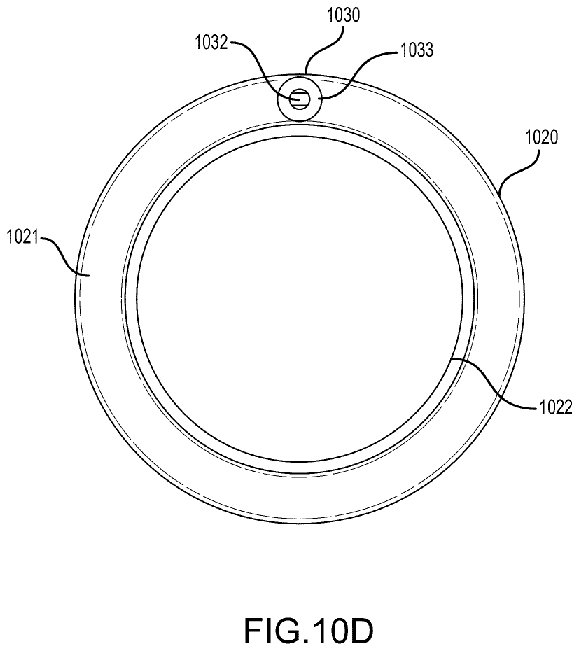

With reference to FIG. 10A is depicted a perspective view of an embodiment of a sealing ring 1020 having a specialized interface 1022 for mechanically interacting with a rotating pump shaft (not shown). The depicted interface has a set of ridges and grooves arranged in the pattern shown in FIG. 4, item 422. Opposite the interface is a flat outer surface 1029, and on each end of the sealing ring is a side wall 1021 (one is visible). An inner cavity (not shown) is housed between the interface, outer surface, and side walls. The side wall on the bearing side includes an inflation orifice 1030 for accommodating a filler valve (not shown) As illustrated, some embodiments of the sealing ring do not include a secondary fill site.

With reference to FIG. 10B is depicted a perspective view of the sealing ring 1020 with specialized interface 1022, this view having a 90° cut out section. In this view, the specialized interface 1022 is shown having a set of ridges 1025 and grooves 1026 in the center portion, a double flange feature 1028 on the inlet side of the interface, and a single flange feature 1027 on the bearing side. Cross sections of the internal cavity 1024 are visible, as is the inflation orifice 1030. The orifice includes an opening 1032 that accesses the internal cavity horizontally, and a socket flange 1033 for holding the valve stem in place.

With reference to FIG. 10C is depicted a side view of the sealing ring 1020 with specialized interface 1022, this view having a translucent outer surface 1029. Features of the interface are visible, including the set of ridges 1025 and grooves 1026 in the center of the interface, and the double flange feature 1028 and single flange feature 1027 on the edges. In this view, the filler valve 1040 is positioned in the socket flange 1033 of the inflation orifice 1030 and supplies gas or liquid through the opening 1032 into the internal cavity 1024.

With reference to FIG. 10D is depicted an end view of the sealing ring 1020 with specialized interface 1022. In this view, the side wall 1021 on the bearing side of the sealing ring is visible, as is the inflation orifice 1030. The socket flange 1033 for securing the filler valve (not shown) is visible, as is the opening 1032 to the internal cavity. The inflation orifice is centered vertically on the side wall for access to the internal cavity.

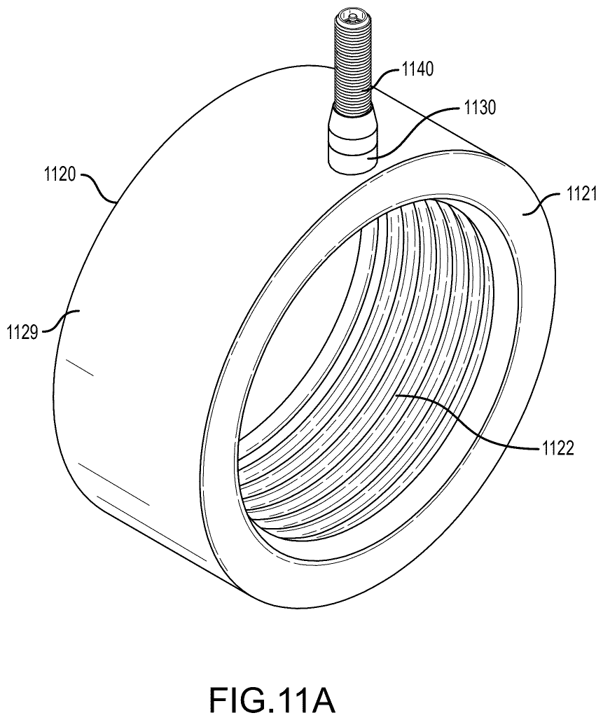

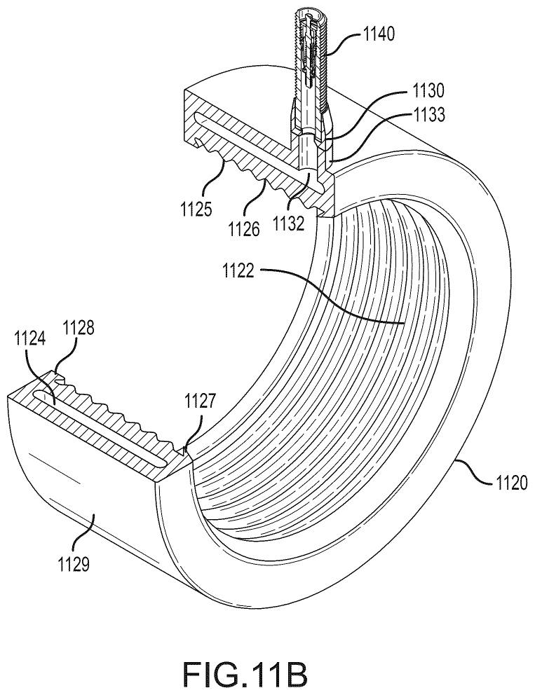

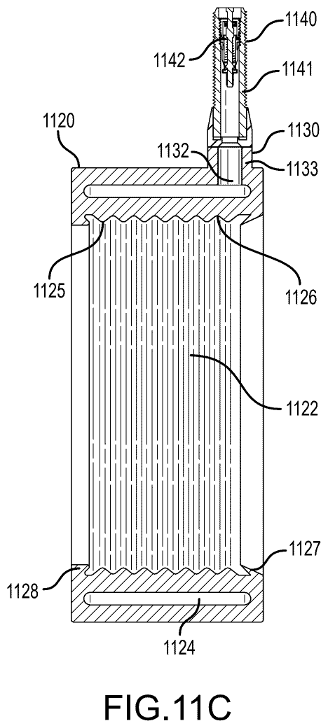

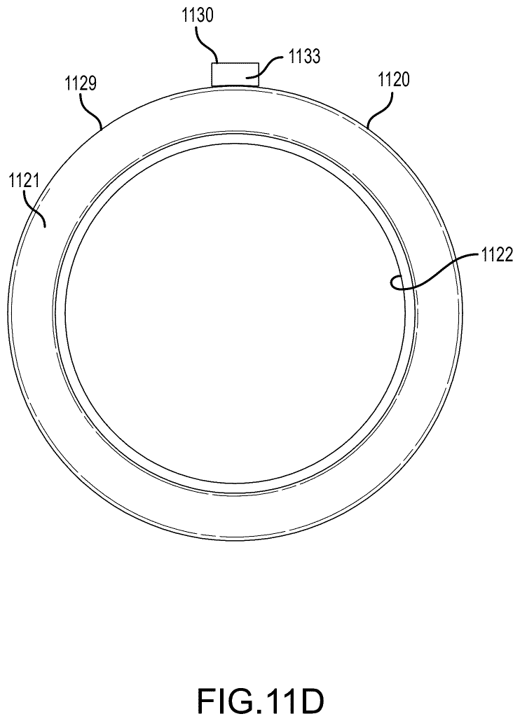

With reference to FIG. 11A is depicted a perspective view of an embodiment of a sealing ring 1120 having a specialized interface 1122 for mechanically interacting with a rotating pump shaft (not shown). The depicted interface has a set of ridges and grooves arranged in the pattern shown in FIG. 5, item 522. Opposite the interface is a flat outer surface 1129, and on each end of the sealing ring is a side wall 1121 (one is visible). An inner cavity (not shown) is housed between the interface, outer surface, and side walls. On the outer surface 1129 near the bearing side is an inflation orifice 1130 for accommodating a filler valve 1140 for filling the inner cavity with air or liquid. In this embodiment, the filler valve is oriented vertically and opens to the internal cavity vertically. Such a filler valve arrangement may be convenient if, for example, there was insufficient room adjacent the sealing ring to accommodate a horizontal entry filler valve such as is featured on FIG. 10C, item 1040.

With reference to FIG. 11B is depicted a perspective view of the sealing ring 1120 with specialized interface 1122, this view having a 90° cut out section. In this view, the specialized interface is shown having a set of ridges 1125 and grooves 1126 in the center portion, a foot feature 1128 on the inlet side of the interface, and a single flange feature 1127 on the bearing side. Cross sections of the internal cavity 1124 are visible, as is the inflation orifice 1130 located on the outer surface 1129. The orifice includes an opening 1132 that accesses the internal cavity vertically, and a socket flange 1133 for holding the valve stem in place. The orifice accommodates a filler valve 1140.

With reference to FIG. 11C is depicted a side view of the sealing ring 1120 with specialized interface 1122, this view having a 180° cut out section. Features of the interface are visible, including the set of ridges 1125 and grooves 1126 in the center of the interface, and the foot feature 1128 and single flange feature 1127 on either edge of the interface. In this view, the filler valve 1140 is positioned vertically in the socket flange 1133 of the inflation orifice 1130, which is oriented vertically and located on the outer surface 1129. The filler valve accesses the internal cavity 1124 through an opening 1132 in the top or outer wall of the cavity. In this view, the hollow valve stem 1141 and valve core 1142 are visible.

With reference to FIG. 11D is depicted an end view of the sealing ring 1120 with specialized interface 1122. In this view, the side wall 1121 on the bearing side of the sealing ring is visible, as is the inflation orifice 1130 situated on the outer surface 1129. The socket flange 1133 for securing the filler valve (not shown) is visible.

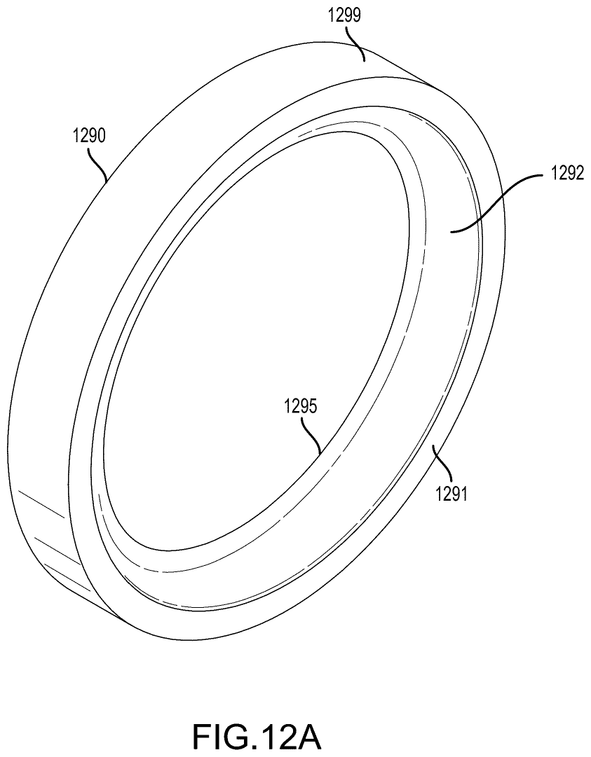

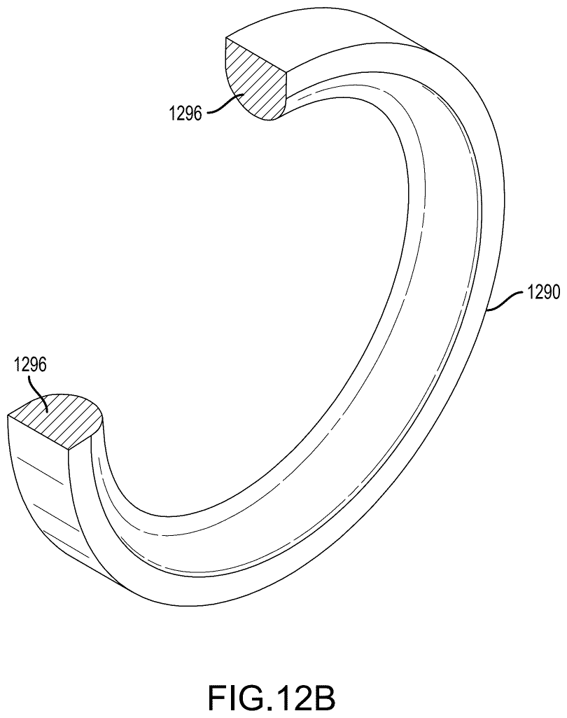

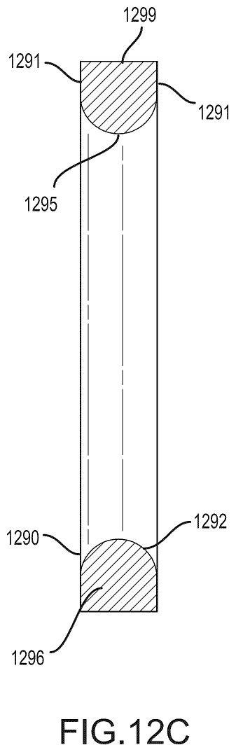

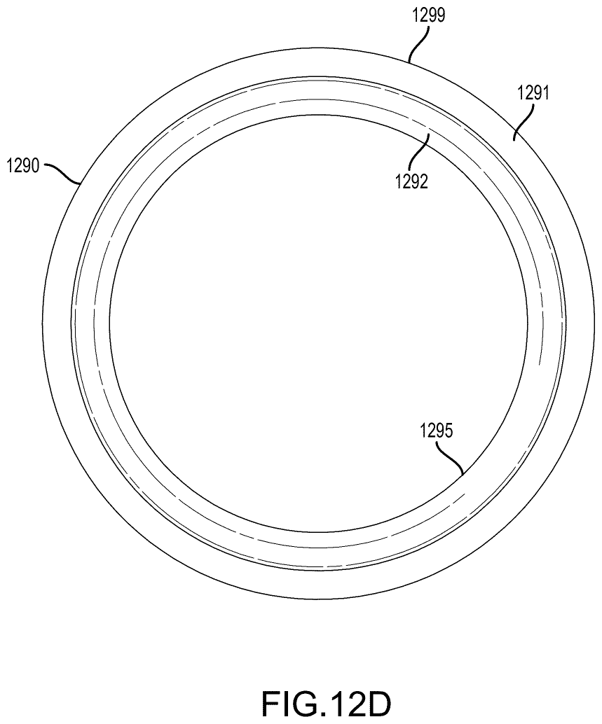

With reference to FIG. 12A is depicted a perspective view of a D-ring 1290 with a solid cross section. The D-ring includes a curved interface 1292 for mechanically interacting with a rotating pump shaft (not shown). A flat outer surface 1299 is located opposite the interface. Orthogonal to the outer surface on either side of the D-ring is a side wall 1291 (one is shown). The interface smoothly curves from the side walls to a rounded apex 1295. With reference to FIG. 12B is depicted a perspective view of the solid D-ring 1290, this view having a 90° cut out section. The “D-shaped” cross section 1296 is visible at either edge of the cutout. With reference to FIG. 12C is depicted a side view of the solid D-ring 1290, this view having a 180° cut out section. Once again, the cross section 1296 is visible at either edge of the cutout. The flat outer surface 1299 is shown oriented orthogonally to the two side walls 1291. The side walls transition to the curve of the interface 1292, which curves into a rounded apex 1295. With reference to FIG. 12D is depicted an end view of the D-ring 1290 with solid cross section. The outer surface 1299 is located opposite the interface 1292, and orthogonal to the side walls 1291 (one side is visible). The side walls transition to the curve of the interface, which curves into a rounded apex 1295. The D-ring 1290 is constructed of heat-resistant silicone, or other suitable material.

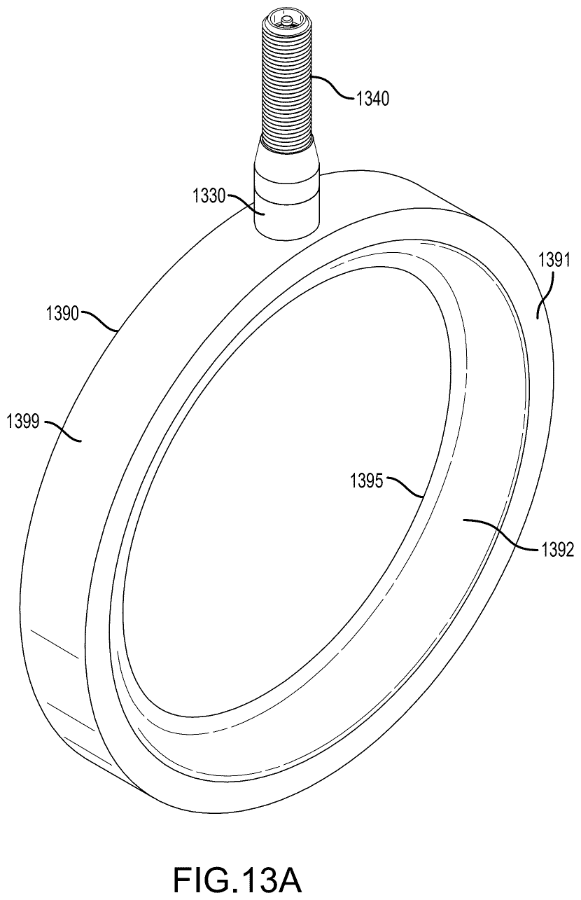

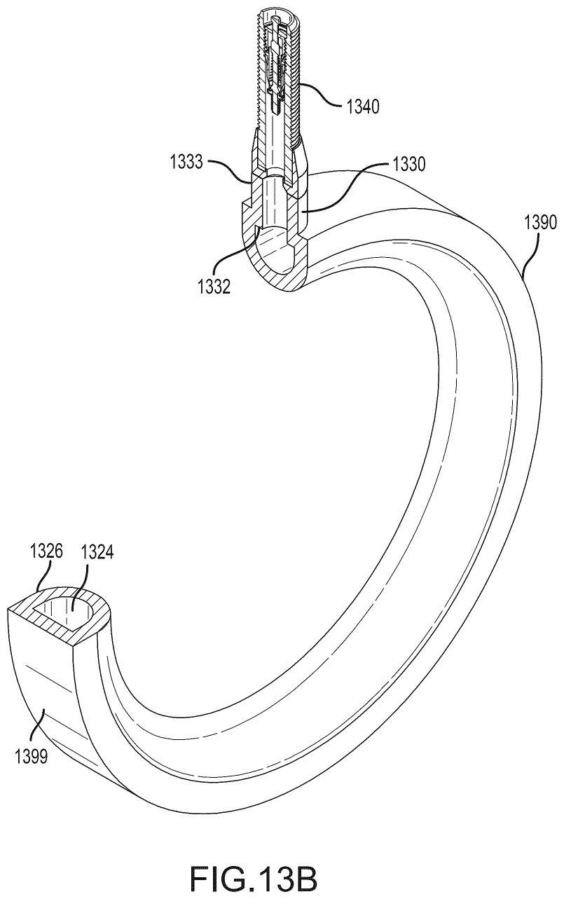

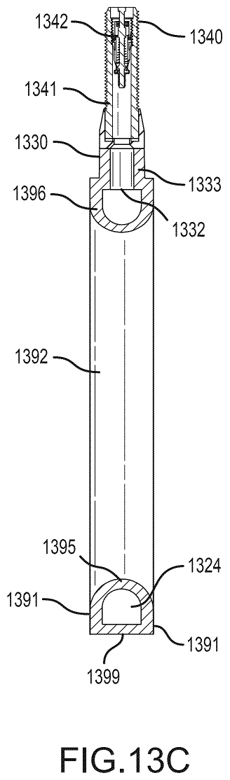

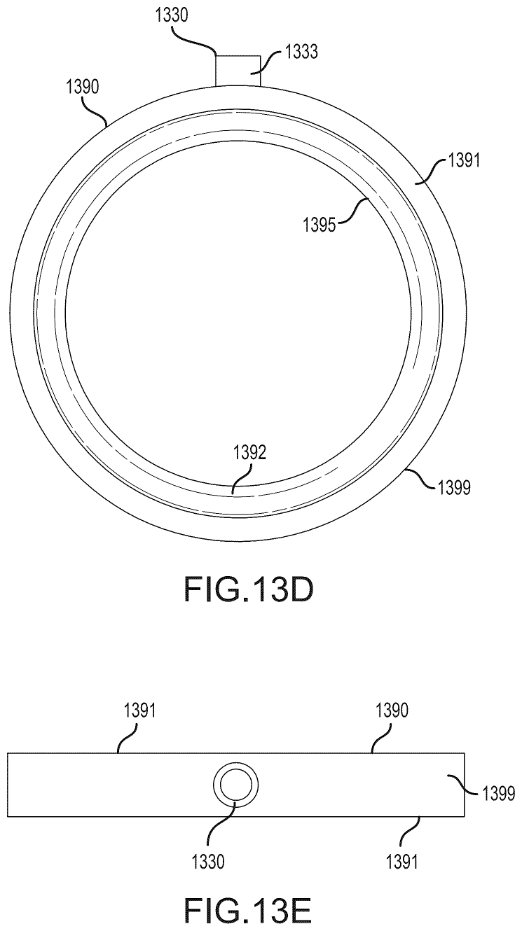

With reference to FIG. 13A is depicted a perspective view of a D-ring 1390 with an open or hollow cross section. The D-ring includes a curved interface 1392 for mechanically interacting with a rotating pump shaft (not shown). A flat outer surface 1399 is located opposite the interface. Orthogonal to the outer surface on either side of the D-ring is a side wall 1391 (one is shown). The interface smoothly curves from the side walls to a rounded apex 1395. On the outer surface 1399 is located a filler orifice 1330 that opens into an internal cavity and accommodates a filler valve 1340. With reference to FIG. 13B is depicted a perspective view of the hollow D-ring 1390, this view having a 90° cut out section. The “D-shaped” cross section 1396 with an internal cavity 1324 is visible at either edge of the cutout. The inflation orifice 1330 is located on the outer surface 1399 and includes an opening 1332 that accesses the internal cavity vertically, and a socket flange 1333 for holding the filler valve 1340 in place.

With reference to FIG. 13C is depicted a side view of the hollow D-ring 1390, this view having a 180° cut out section. Once again, the cross section 1396 is visible at either edge of the cutout. The flat outer surface 1399 is shown oriented orthogonally to the two side walls 1391, and the curve of the interface 1392 is shown culminating in a rounded apex 1395. Between the interface and outer surface is an internal cavity 1324. Located on the outer surface at the top of the D-ring is an inflation orifice 1330. The orifice includes a socket flange 1333 for holding the filler valve 1340 in place, and an opening 1332 that provides access to the internal cavity for introduction of gas or liquid to the cavity. Also visible is the hollow valve stem 1341 and the valve core 1342.

With reference to FIG. 13D is depicted an end view of the D-ring 1390 with internal cavity. The outer surface 1399 is located opposite the interface 1392, and orthogonal to the side walls 1391 (one side is visible). The side walls transition to the curve of the interface, which curves into a rounded apex 1395. The inflation orifice 1330 is located on the outer surface. Visible here is the socket flange 1333 for securing the filler valve (not shown). With reference to FIG. 13E is depicted a top view of the D-ring 1390 with internal cavity. Here the inflation orifice 1330 is shown located on the outer surface 1399 centered between the side walls 1391.

### Internal Lubrication

### Via-Seal Lubrication

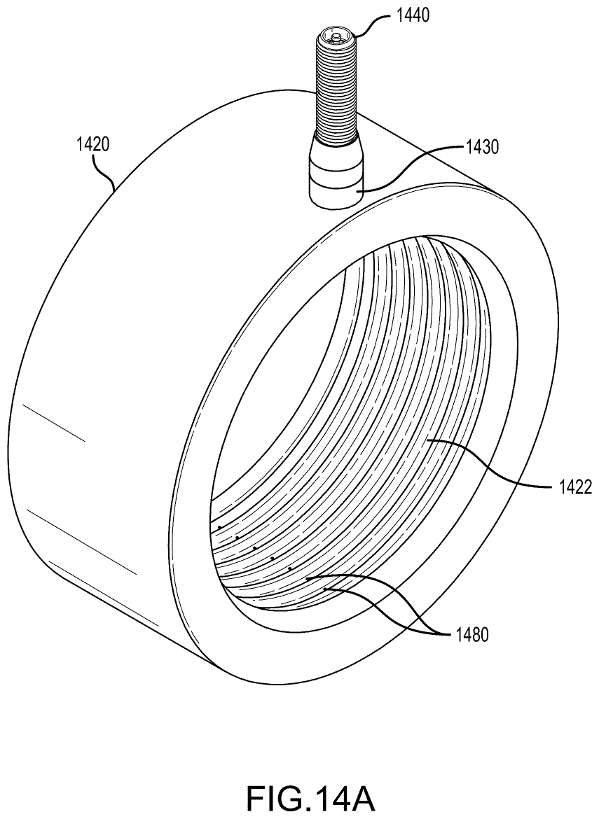

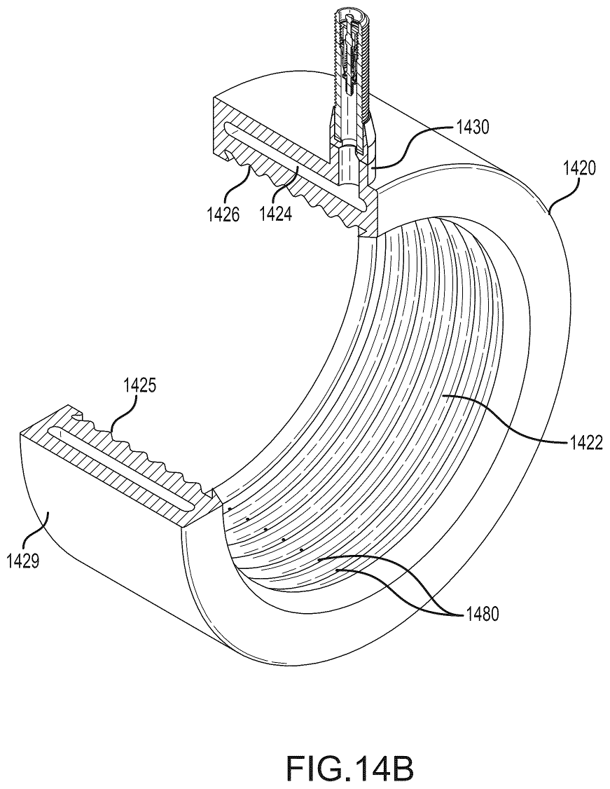

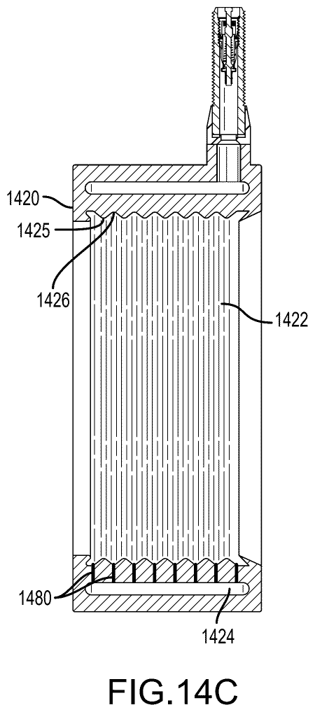

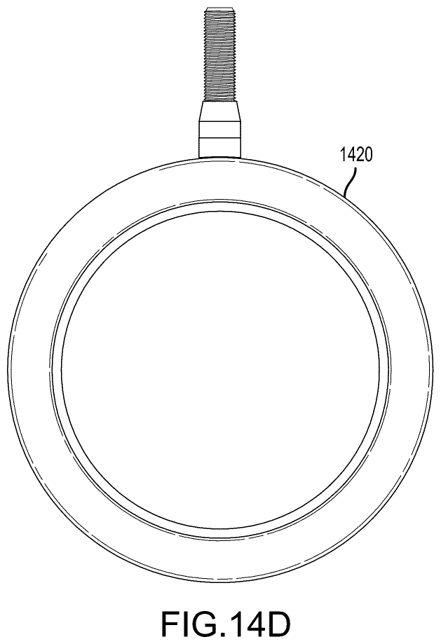

With reference to FIG. 14A is depicted a perspective view of an embodiment of a sealing ring 1420 having one or more lubrication ports 1480 for internal via-seal lubrication. Via-seal lubrication is accomplished by including a plurality of lubrication ports (seven are shown) connecting the internal cavity of the sealing ring to shaft interface 1422. The ports are located 180 degrees from the inflation orifice 1430, i.e., on the bottom of the sealing ring, arranged along the interface within the ridge and groove pattern (if present). When ridges and grooves are present, the ports are located within grooves since the grooves provide a location for holding lubricant near the shaft. Embodiments with via-seal lubrication are pressurized with a lubricant, such as an oil or grease, that is filled into the cavity through the inflation orifice 1430 and filler valve 1440.

Lubricant is fed into the cavity by use of an automatic grease dispenser, such as is used in the art. Automatic grease dispensers use a spring, pressurized gas, or electric motor to deliver a constant pressurized flow of grease to the sealing ring. The amount of lubricant supplied to the sealing ring is primarily based on operational temperature. The temperature of the sealing ring is monitored by use of a temperature sensor, e.g., a temperature probe or thermal camera, and the grease dispenser is configured to supply a specified pressure to the sealing ring to ensure the grease pressure does not exceed the seal pressure, which would render the seal ineffective. The specified grease pressure is secondarily dependent on the size of the shaft used in the pump, the rotational speed of the shaft during pump operation, and the type of bearings used in the pump.

When pressurized, the ports 1480 on the self-lubricating sealing ring allow lubricant to pass from the internal cavity to the interface, where it lubricates the mechanical interaction between the shaft and sealing ring. The amount of lubricant moving from the cavity to the interface is a function of pressure in the seal cavity, viscosity of the lubricant, and size of the lubrication ports. Such factors are configured to provide an adequate amount of lubricant to the shaft during pump operation.

With reference to FIG. 14B is depicted a perspective view of the sealing ring 1420 with lubrication ports 1480 for via-seal lubrication, this view having a 90° cut out section. In this view, the interface 1422 is shown having a set of ridges 1425 and grooves 1426 in the center portion, and edge features on either side. The lubrication ports are located in the grooves of the interface. Cross sections of the internal cavity 1424 are visible, as is the inflation orifice 1430 located on the outer surface 1429.

With reference to FIG. 14C is depicted a side view of the sealing ring 1420 with lubrication ports 1480 for via-seal lubrication, this view having a 180° cut out section. Features of the interface 1422 are visible, including the set of ridges 1125 and grooves 1126 in the center of the interface. The lubrication ports 1480 are arranged along the bottom of the sealing ring and are located within the grooves 1426. The ports fluidically connect the internal cavity 1424 to the interface, and allow a specified rate of lubricant to flow from the cavity to lubricate the shaft. Lubricant is deposited within the grooves to ensure it is contained by the seal against the rotating shaft surface.

With reference to FIG. 14D is depicted an end view of the sealing ring 1420 with lubrication ports for via-seal lubrication. In this view, the sealing ring with via-seal lubrication is shown to be similar to previous embodiments.

### Via-Shaft Lubrication

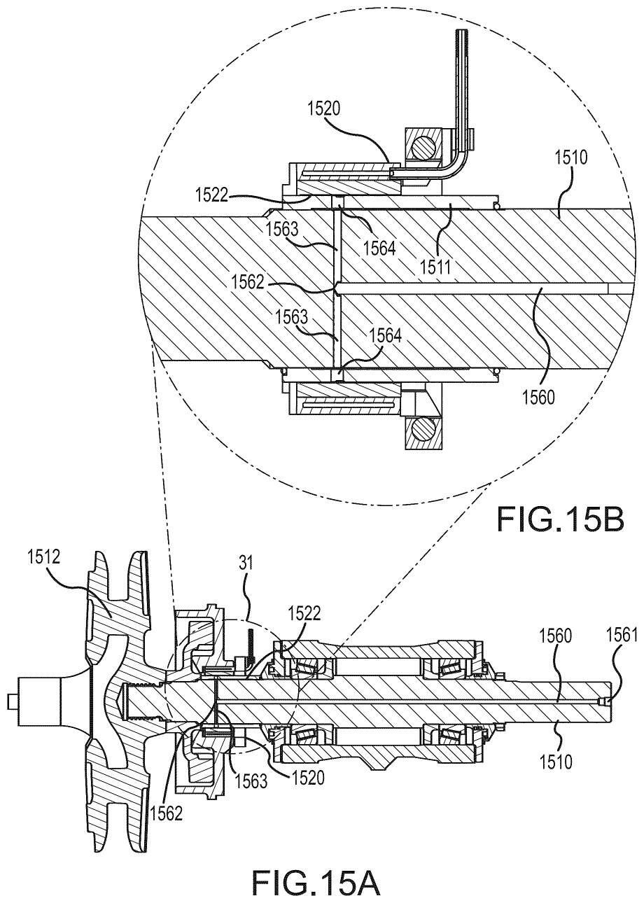

With reference to FIG. 15A, is shown a cutaway side view of a shaft and impeller assembly including a cross-sectional depiction of a seal with internal via-shaft lubrication as used in embodiments of the disclosed invention.

A trans-casing rotary pump transmission shaft 1510 turns an impeller 1512 and passes through a seal 1520. The shaft includes a main channel or passage 1560 located along the rotational axis of the shaft, for conveying lubricant to the seal. The channel is fed lubricant through a port 1561 located at the end of the shaft that is opposite the impeller. The main channel terminates in a junction or seal junction 1562 where it connects to one or more branch channel(s) 1563 (two are shown) that extend orthogonally from the main channel to the outer surface of the shaft. The junction is located within the lateral confines of the seal so that the branch channel(s) transport lubricant from the main channel to the space between the shaft and seal interface 1522. Preferably, the junction is placed so that lubricant is delivered to the center of the seal interface. Typically, there will be no more than 4 branch passages per seal or bearing, limited in number to avoid compromise to the structural integrity of the shaft.

With reference to FIG. 15B, is depicted a close-up view of the area within the circle 31 of FIG. 15A, showing a side cutaway view of a seal assembly 1520 with via-shaft lubrication, as used in embodiments of the disclosed invention. As shown, the seal assembly includes a flat interface 1522 to mechanically interact with the shaft 1510. The main channel 1560 transports lubricant to the seal junction 1562, which in turn is connected to one or more branch channels 1563 (two are shown). The main channel is, e.g., 3 mm in diameter, and the branch channel(s) are e.g., 1 mm in diameter.

Surrounding the shaft is a wear sleeve 1511 for controlling the mechanical interaction between the shaft and the seal. The wear sleeve is permanently installed on the shaft and turns with the shaft when it rotates. The sleeve may be made from hardened steel or other suitable material. The wear sleeve prevents excessive wear on the shaft due to the seal but does create another interface for sealing. The sleeve includes a receptor channel 1564 (two are shown) paired to each branch channel and aligned with the branch channel so that lubricant passes through the wear sleeve to the seal interface 1522. Having a receptor channel through the wear sleeve allows for efficient sealing and reduces leakage. In operation, lubricant travels down the main channel to the junction and into each branch channel for transport to the outer surface of the shaft. From there, the lubricant enters the paired receptor channel through the wear sleeve and is carried to the seal interface where it lubricates contact points between the interface and the wear sleeve.

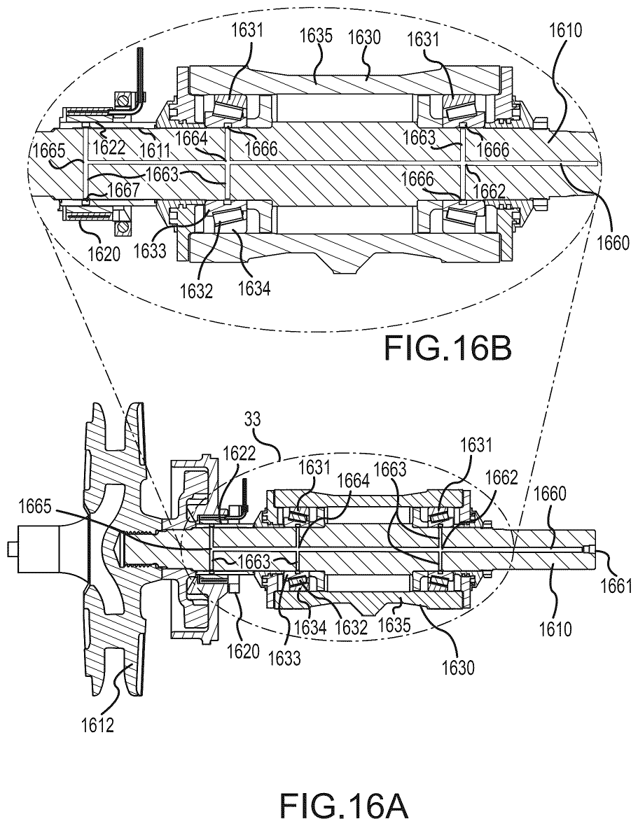

With reference to FIG. 16A, is shown a cutaway side view of a shaft and impeller assembly including a cross-sectional depiction of a seal assembly and a bearing assembly, each with via-shaft lubrication, as used in embodiments of the disclosed invention. A trans-casing rotary pump transmission shaft 1610 turns an impeller 1612 and passes through a seal 1620 and a bearing assembly 1630. The bearing assembly includes one or more roller bearings 1631 (two sets are shown). Each roller bearing includes a set of rollers 1632 located between an inner ring 1633 and an outer ring 1634. The inner ring and outer ring mechanically interact with the rollers, the shaft 1610, and bearing housing 1635 to restrain the shaft's non-rotational motion and reduce friction in the shaft's rotational motion.

The shaft includes a main channel or passage 1660 located along the rotational axis of the shaft for conveying lubricant to the bearing(s) and seal. The channel is fed lubricant through a port 1661 located at the end of the shaft opposite the impeller. The main channel enters a bearing junction 1662 where it connects to one or more branch channel(s) 1663 (two are shown) that extend orthogonally from the main channel to the outer surface of the shaft. The bearing junction is located within the lateral edges of the bearing so that the branch channel(s) connecting to the bearing junction transport lubricant from the main channel to the space between the shaft and inner ring 1633 of a bearing 1631. Preferably, the branch junction is located so that lubricant is delivered to the center of the bearing.

When there is more than one set of bearings, the main channel 1660 includes additional bearing junctions 1664 (one is shown), each of which connects to one or more branch channels 1663 (two are shown). The branch channel(s) connecting to the additional bearing junction also transport lubricant from the main channel to the space between the shaft and inner ring 1633. Past the bearing junctions, the main channel continues along the shaft until it terminates in a seal junction 1665 where it connects to one or more branch channel(s) 1663 (two are shown) that extend orthogonally from the main channel to the outer surface of the shaft. The branch channel(s) connecting to the seal junction transport lubricant from the main channel to the space between the shaft and seal interface 1622.

With reference to FIG. 16B, is depicted a close-up view of the area within the circle 33 of FIG. 16A, showing a side cutaway view of a seal assembly 1620 and bearing assembly 1630, each with via-shaft lubrication, as used in embodiments of the disclosed invention. In the close-up view, the main channel 1660 is shown with a bearing junction 1662 located at or near the center of a bearing 1631, where it connects to one or more branch channel(s) 1663 (two are shown) that extend orthogonally from the main channel to the outer surface of the shaft 1610. The branch channel(s) connecting to the bearing junction transport lubricant from the main channel to the space between the shaft and inner ring 1633 of the bearing. The inner ring includes a bearing receptor channel 1666 (two are shown) paired to each branch channel and aligned with the branch channel so that lubricant passes through the inner ring to the rollers 1632. In operation, lubricant travels down the main channel to the bearing junction and into each branch channel for transport to the outer surface of the shaft. From there, the lubricant enters the paired bearing receptor channel and is carried to the roller where it lubricates contact points between the inner ring, outer ring and rollers.

When there is more than one set of bearings, the main channel 1660 includes additional bearing junctions 1664 (one is shown), that connects to one or more branch channels 1663 (two are shown). The branch channel(s) connecting to the additional bearing junction also transport lubricant from the main channel to the space between the shaft and inner ring 1633, and into another set of bearing receptor channels 1666 for transport to the bearing 1631.

After the one or more bearing junctions 1662, 1664, the main channel 1660 transports lubricant to the seal junction or terminal junction 1665, which in turn is connected to one or more branch channels 1663 (two are shown). The seal assembly 1620 and the via-shaft lubrication of the seal is similar to that described above with respect to FIG. 15B, item 1520. Namely, the seal is shown with a flat interface 1622 to mechanically interact with the shaft 1610. Surrounding the shaft is a wear sleeve 1611 having a seal receptor channel 1667 (two are shown) paired to each branch channel that connects the branch channel to the seal interface 1622. Lubricant travels up the main channel, to the seal junction 1665, from which it travels out the one or more branch channels to the seal receptor channel through the wear sleeve, and from there to the seal interface to lubricate the seal.

Upon reading this disclosure and through the disclosed principles herein, those of skill in the art will appreciate still additional alternative structural and functional designs for a device, a system, and a process for internally pressurized and lubricated shaft seals and internally lubricated shaft bearings. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope of the invention.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the present invention. In addition, where claim limitations have been identified, for example, by a numeral or letter, they are not intended to imply any specific sequence.

This has been a description of the disclosed invention along with a preferred method of practicing the invention.

1. A device for sealing a pump, comprising:
a sealing ring including an interface for mechanically interacting with a shaft of the pump, and a cavity accessible by an orifice;
wherein the cavity is configured to be pressurized with a medium during pump operation, and wherein the sealing ring is configured to increase pressure on the shaft when the medium is added and to reduce pressure on the shaft when the medium is removed; and
a lubrication port fluidically connecting the cavity to the interface, and configured to transport a lubricant from the cavity to the shaft.

2. The device for sealing a pump of claim 1, wherein the sealing ring is configured to maintain a pressure level on the shaft.

3. The device for sealing a pump of claim 2, wherein the pressure level is adjustable to an outlet pressure required by the pump.

4. The device for sealing a pump of claim 1, wherein the medium is one of a liquid, a gas, or a gel.

5. The device for sealing a pump of claim 1, wherein the medium functions to dissipate heat from the sealing ring.

6. The device for sealing a pump of claim 1, wherein the cavity is configured to deflate by the application of suction through the orifice.

7. The device for sealing a pump of claim 1, wherein the sealing ring is configured to increase the net positive suction head of the pump.

8. The device for sealing a pump of claim 1, the interface further comprising a lip seal to prevent infiltration of pumped material between the interface and the shaft.

9. The device for sealing a pump of claim 1, wherein the sealing ring is configured to maintain a plurality of pressure levels on the shaft.

10. (canceled)

11. A system for pumping a material, comprising:
a pump, comprising an impeller for moving the material, a shaft for turning the impeller, and a seal for preventing contact between the material and the shaft;
wherein the seal includes an interface for mechanically interacting with the shaft, and a cavity for selectively pressurizing or depressurizing the seal during operation of the pump, and wherein the seal includes a lubrication port for transporting a lubricant from the cavity to the shaft.

12. The system for pumping a material of claim 11, wherein the material is one of a liquid or a slurry.

13. he system for pumping a material of claim 11, wherein the pump includes an expeller.

14. (canceled)

15. The system for pumping a material of claim 11, the shaft further comprising a lubrication system for transporting lubricant, comprising a main channel located along a rotational axis of the shaft, and a seal junction for fluidically connecting the main channel to one or more seal branch channels, wherein the one or more seal branch channels extends orthogonally from the main channel to the interface.

16. The system for pumping a material of claim 15, the system further comprising a bearing assembly located on the shaft and a bearing junction for fluidically connecting the main channel to one or more bearing branch channels, wherein the one or more bearing branch channels extends orthogonally from the main channel to the bearing assembly.

17. The system for pumping a material of claim 11, wherein the seal comprises one or more D-rings.

18. The system for pumping a material of claim 11, the seal further comprising wet gland packing material.

19. The system for pumping a material of claim 11, the interface further comprising a lip seal for preventing infiltration of the seal by pumped material, and a set of alternating ridges and grooves for contacting the shaft and holding lubricant, respectively.

20. The system for pumping a material of claim 11, wherein the interface is flat.
